(19) United States
(12) Patent Application Publication
(10) Pub. No.: US 2019/0030671 A1
(43) Pub. Date: Jan. 31, 2019

(54) MACHINE TOOL

(71) Applicant: FANUC CORPORATION, Yamanashi (JP)

(72) Inventor: Yuuta TOOYAMA, Yamanashi (JP)

(73) Assignee: FANUC CORPORATION, Yamanashi (JP)

(21) Appl. No.: 16/020,301

(22) Filed: Jun. 27, 2018

(30) Foreign Application Priority Data
Jul. 31, 2017 (JP) 2017-147924

(51) Int. Cl. B23Q 11/10; B23Q 11/08; B23Q 3/10

(52) U.S. Cl. CPC B23Q 11/1015; B23Q 3/10; B23Q 11/08

(57) ABSTRACT

A machine tool includes a bed having an arrangement space; a tank capable of being disposed in the arrangement space; a coolant leakage prevention plate pivotable about a shaft extending in a horizontal direction; and a rotary piece pivotable about the shaft together with the coolant leakage prevention plate. The coolant leakage prevention plate is configured to be held at either a closing position or an open position. At the closing position, the coolant leakage prevention plate hangs down from the shaft to cover at least a part of the tank. When the tank is pulled out from the arrangement space, the coolant leakage prevention plate is pushed up by the tank, whereby the coolant leakage prevention plate is caused to be at the open position. When the coolant leakage prevention plate is positioned at the opening position, the rotary piece is held to hang down from the shaft.

This application is based on and claims the benefit of priority from Japanese Patent Application No. 2017-147924, filed on Jul. 31, 2017, the content of which is incorporated herein by reference.

### BACKGROUND OF THE INVENTION

### Field of the Invention

The present invention relates to a machine tool having a structure for preventing coolant from leaking.

### Related Art

Machine tools are conventionally known, each of which includes a coolant tank for separating and recovering the coolant and chips generated during machining of a workpiece (refer to Patent Documents 1 and 2, as examples). The machine tool which includes a coolant tank detachably inserted and attached on a side part of a bed serving as a base among such machine tools may be configured with a sheet metal attached to the bed so that another sheet metal is hooked with a nail to the sheet metal to cover at least a part of the coolant tank, thereby preventing coolant from leaking. According to such a structure, when the coolant tank is pulled out for maintenance such as cleaning, the sheet metal hooked with the nail is lifted without being detached from the other sheet metal.
Patent Document 1: Japanese Unexamined Patent Application, Publication No. H01-140943
Patent Document 2: Japanese Utility Model Application Publication No. H07-048365

### SUMMARY OF THE INVENTION

Insertion of the coolant tank takes time and effort since the sheet metal hooked with the nail needs to be temporarily detached from the other sheet metal, whereupon the coolant tank is inserted, and thereafter the sheet metal needs to be hooked again. If the coolant tank is inserted without removing the sheet metal, the coolant tank pushes the sheet metal, which may lead to damage in one of them.

The object of the present invention is to provide a machine tool being simple in maintenance and having a structure for preventing coolant from leaking.

(1) The present invention provides a machine tool (for example, a machine tool 1 described below) including a bed (for example, a bed 2 described below) having an arrangement space (for example, an arrangement space 22 described below) on the side part thereof; a tank (for example, a coolant tank 4 described below) which is capable of being disposed in the arrangement space by insertion and is capable of being pulled out from the arrangement space, and which houses coolant generated during machining of a workpiece; a coolant leakage prevention plate (for example, a coolant leakage prevention plate 52 described below) pivotable about a a shaft (for example, a shaft 511 of a hinge 51 described below) extending in a horizontal direction, wherein the coolant leakage prevention plate is configured to be held at either a closing position or an open position, wherein at the closing position, the coolant leakage prevention plate hangs down from the shaft to cover at least a part of the tank which is inserted in the arrangement space, and wherein, when the tank is pulled out from the arrangement space, the coolant leakage prevention plate is pushed up by the tank being pulled out, whereby the coolant leakage prevention plate is caused to be at the open position to expose the arrangement space; and a rotary piece (for example, a rotary piece 53 described below) pivotable about the shaft together with the coolant leakage prevention plate, wherein, when the coolant leakage prevention plate is positioned at the opening position, the rotary piece is configured to be held to hang down from the shaft, and wherein when the rotary piece is pushed by the tank which is inserted into the arrangement space, the rotary piece rotates together with the coolant leakage prevention plate, thereby positioning the coolant leakage prevention plate at the closing position.

(2) In the machine tool according to (1), wherein the coolant leakage prevention plate and the rotary piece are pivotably supported by the shaft capable of holding an angle.

The present invention enables the provision of a machine tool being simple in maintenance and having a structure for preventing coolant from leaking.

### BRIEF DESCRIPTION OF THE DRAWINGS

FIG. 1 is a cross-sectional view illustrating a schematic configuration of a characteristic portion of a machine tool according to one embodiment of the present invention.

FIG. 2 shows a state before a coolant leakage prevention plate is pushed up in the process of a coolant tank being pulled out.

FIG. 3 shows a state after the coolant leakage prevention plate is pushed up in the process of the coolant tank being pulled out.

FIG. 4 shows a state before a rotary piece is pushed up in the process of the coolant tank being inserted.

### DETAILED DESCRIPTION OF THE INVENTION

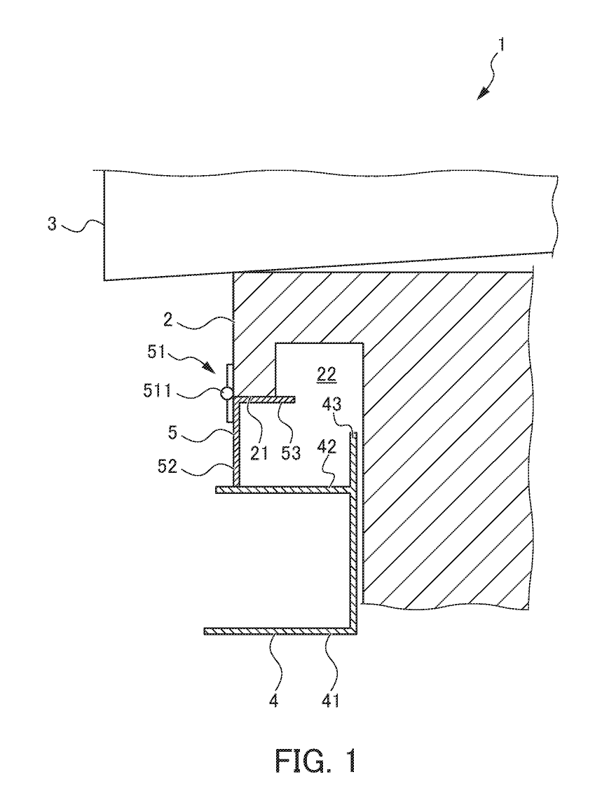

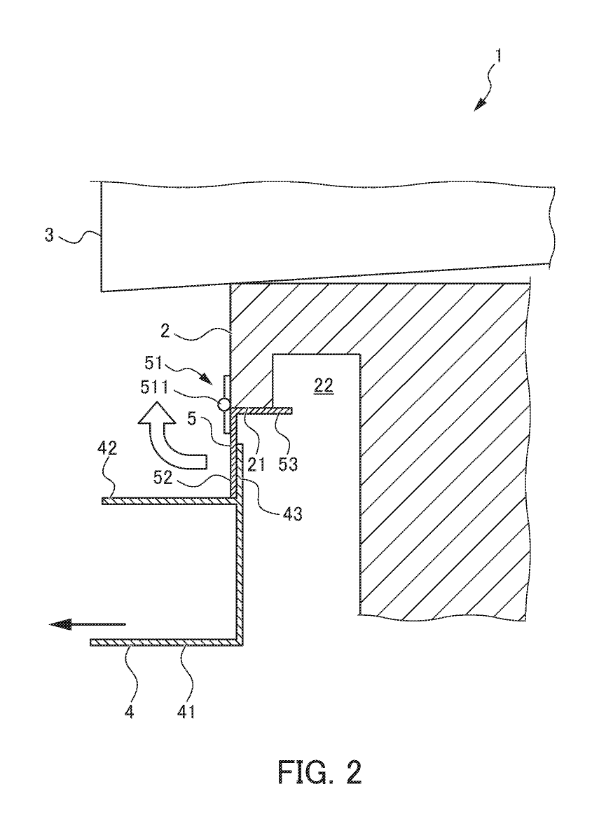

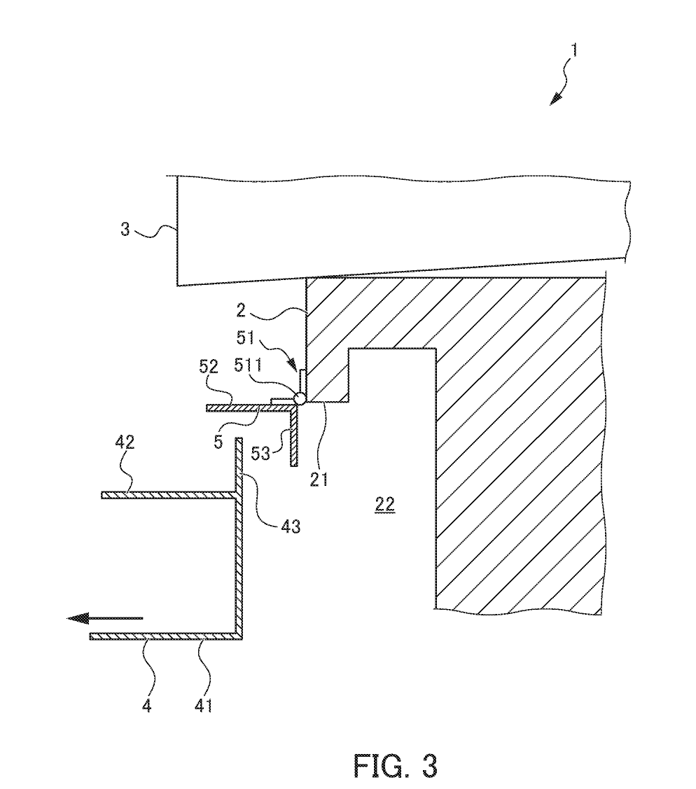

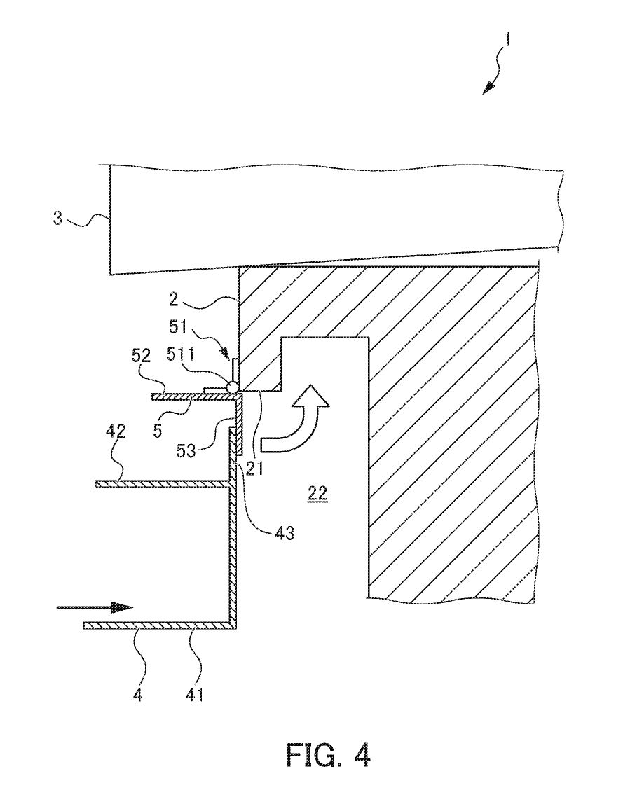

One embodiment of a machine tool according to the present invention will be described below with reference to FIG. 1 to FIG. 4. FIG. 1 is a cross-sectional view illustrating a schematic configuration of a characteristic portion of the machine tool according to one embodiment of the present invention. FIG. 2 shows a state before a coolant leakage prevention plate is pushed up in the process of a coolant tank being pulled out. FIG. 3 shows a state after the coolant leakage prevention plate is pushed up in the process of the coolant tank being pulled out. FIG. 4 shows a state before a rotary piece is pushed up in the process of the coolant tank being inserted.

As shown in FIG. 1, a machine tool 1 of the present embodiment includes a bed 2, a column (not shown), a spindle head (not shown), a saddle (not shown), a work table (not shown), a splash guard 3, a coolant tank (tank) 4, and a coolant leakage prevention tool 5.

The bed 2, which is made of a casting, constitutes the base of the machine tool 1. The column (not shown), the spindle head (not shown), the saddle (not shown), the work table (not shown), and the splash guard 3 are disposed above the bed 2. The column stands from the rear portion of the bed 2. The spindle head is attached to the front face of the column so as to be movable up and down. A tool (not shown) is attached to the lower end of the spindle head. The saddle is disposed at the front portion of the bed so as to be movable in the front-rear direction. The work table is provided on the saddle so as to be movable in the left-right direction. A work (not shown) is fixed on the work table.

An insertion port 21 through which the coolant tank 4 is detachably inserted is formed at a lower side of a side part of the bed 2. The term “side part” herein is understood broadly to include a front part and a rear part, not intended to exclude the front part or the rear part. An arrangement space 22 in which the coolant tank 4 inserted through the insertion port 21 is detachably disposed is formed inside the insertion port 21 of the bed 2. The coolant leakage prevention tool 5 is provided on the upper edge of the insertion port 21 of the bed 2.

The splash guard 3 is provided above the bed 2. The splash guard 3 surrounds the machining area (the area in which the spindle head and the work table are disposed) of the machine tool 1, thereby preventing coolant and chips splashing from the machining portion from splashing to the outside.

The coolant tank 4 is detachably inserted through the insertion port 21 of the bed 2 into the arrangement space 22 inside the bed 2. In the state where the coolant tank 4 is disposed in the arrangement space 22 inside the bed 2 after being inserted through the insertion port 21 of the bed 2, the coolant tank 4 houses the coolant and chips generated during machining of a workpiece.

Specifically, the coolant tank 4 includes a tank body 41 and a chip pan 42. The tank body 41, which has a shape with the top side thereof opened, receives the coolant and chips recovered from the machining area of the machine tool 1, and houses the coolant separated from the chips by the chip pan 42. The chip pan 42, which is a filter provided inside the tank body 41, separates the chips from the coolant and chips received by the tank body 41, and allows the separated coolant to pass through to the bottom of the tank body 41.

The coolant leakage prevention tool 5 is provided on the upper edge of the insertion port 21 of the bed 2. In the state where the coolant tank 4 is disposed in the arrangement space 22 inside the bed 2, the coolant leakage prevention tool 5 closes a gap generated at the insertion port 21 of the bed 2, thereby preventing the coolant and chips recovered in the coolant tank 4 from splashing to the outside. The term “preventing” herein includes not only the case of complete prevention but also the case of substantial prevention. This also applies to “preventing” with respect to a coolant leakage prevention plate 52.

Specifically, the coolant leakage prevention tool 5 includes a hinge 51, the coolant leakage prevention plate 52, and a rotary piece 53.

The pair of hinges 51 is attached to the upper edge of the insertion port 21 of the bed 2 so as to be spaced apart in the left-right direction. The hinge 51 has a shaft 511 extending along the horizontal direction corresponding to a lateral direction. It is noted that the length and number of hinges are not limited to these. The hinge 51 supports the coolant leakage prevention plate 52 and the rotary piece 53 so as to be rotatable and so that the angles of the coolant leakage prevention plate 52 and the rotary piece 53 can be held. That is, the hinge 51 holds the coolant leakage prevention plate 52 and the rotary piece 53 in postures having arbitrary angles. It is noted that the description about the hinge 51 is appropriately replaced with “the shaft 511 of the hinge 51.”

The coolant leakage prevention plate 52 is made of a sheet metal, and is formed integrally with the rotary piece 53. The coolant leakage prevention plate 52 and the rotary piece 53 are subjected to folding so as to have a substantial L-shape in a cross-sectional view. The coolant leakage prevention plate 52 is supported so as to be rotatable with respect to the hinge 51, and to be held at the closing position where, in the state where the coolant tank 4 is inserted in the arrangement space 22 of the bed 2, the coolant leakage prevention plate 52 hangs down from the hinge 51 to cover at least a part of the coolant tank 4 (refer to FIG. 2), and at the opening position where, in the process of the coolant tank 4 being pulled out from the arrangement space 22 of the bed 2, the coolant leakage prevention plate 52 is pushed up outward by the coolant tank 4 to expose the arrangement space 22 (refer to FIG. 3).

The rotary piece 53 is supported so as to be rotatable with respect to the hinge 51 integrally with the coolant leakage prevention plate 52, and to be held at the position where the rotary piece 53 hangs down from the hinge 51 when the coolant leakage prevention plate 52 is positioned at the opening position (refer to FIG. 3). The rotary piece 53 is pushed in toward the arrangement space 22 by the coolant tank 4 in the process of the coolant tank 4 being inserted into the arrangement space 22 of the bed 2, and thus the rotary piece 53 rotates integrally with the coolant leakage prevention plate 52, thereby positioning the coolant leakage prevention plate 52 at the closing position (refer to FIG. 1).

It is noted that the coolant leakage prevention plate 52 and the rotary piece 53 may not be made of a plate having a uniform thickness, and may be formed of other material than sheet metal. The coolant leakage prevention plate 52 and the rotary piece 53 may be configured with plural integrated parts, as long as the coolant leakage prevention plate 52 and the rotary piece 53 are able to rotate integrally.

The operation of the coolant leakage prevention tool 5 is described below with reference to FIG. 2, FIG. 3, FIG. 4, and FIG. 1. As shown in FIG. 2, in the process of the coolant tank 4 being pulled out from the arrangement space 22 of the bed 2, the coolant leakage prevention plate 52 positioned at the closing position to hang down from the hinge 51 rotates so as to be pushed up outward by the inner wall of a raised part 43 of the coolant tank 4. The rotary piece 53 rotates integrally with the rotation of the coolant leakage prevention plate 52, and then is positioned at the position to hang down from the hinge 51, as shown in FIG. 3.

On the other hand, as shown in FIG. 4, in the process of the coolant tank 4 being inserted through the insertion port 21 of the bed 2 into the arrangement space 22 of the bed 2, the rotary piece 53 positioned at the position to hang down from the hinge 51 rotates so as to be pushed in toward the arrangement space 22 by the outer wall of the raised part 43 of the coolant tank 4. The coolant leakage prevention plate 52 rotates integrally with the rotation of the rotary piece 53, and then is positioned at the closing position to hang down from the hinge 51, as shown in FIG. 1.

The machine tool 1 according to the present embodiment exhibits the following effects, as an example. The machine tool 1 according to the present embodiment includes the bed 2 having the arrangement space on the side part thereof; the tank 4 which is capable of being disposed in the arrangement space 22 by insertion and capable of being pulled out from the arrangement space 22, and which houses the coolant generated during machining of a workpiece; the coolant leakage prevention plate 52 which is rotatable with respect to the shaft 511 of the hinge 51 extending in the lateral direction, and which is supported to be held at the closing position where the coolant leakage prevention plate 52 hangs down from the hinge 51 in the state where the tank 4 is inserted in the arrangement space 22 to cover at least a part of the tank 4, and at the opening position where the coolant leakage prevention plate 52 is pushed up by the tank 4 in the process of the tank 4 being pulled out from the arrangement space 22, to expose the arrangement space 22; and the rotary piece 53 which is rotatable with respect to the hinge 51 integrally with the coolant leakage prevention plate 52, and which is supported to be held at the position where the rotary piece 53 hangs down from the hinge 51 when the coolant leakage prevention plate 52 is positioned at the opening position, and is pushed in by the tank 4 in the process of the tank 4 being inserted into the arrangement space 22 and thus the rotary piece 53 rotates integrally with the coolant leakage prevention plate 52, thereby positioning the coolant leakage prevention plate 52 at the closing position.

Accordingly, in the process of the coolant tank 4 being pulled out for maintenance such as cleaning, or in the process of the coolant tank 4 being inserted, the coolant leakage prevention plate 52 needs not to be detached, which simplifies the maintenance thereof, resulting in a shortening of maintenance time. In addition, the coolant leakage prevention plate 52 is prevented from being damaged.

The present invention is not limited to the above-described embodiment. Various types of changes and modifications are possible. In an example, although the coolant leakage prevention plate 52 and the rotary piece 53 are rotatably supported by the hinge 51 capable of holding an angle, the present invention is not limited thereto. That is, the shaft extending in the lateral direction is not limited to the shaft 511 of the hinge 51. The coolant leakage prevention plate 52 and the rotary piece 53 may be rotatably supported by a shaft not holding an angle, and the coolant leakage prevention plate 52 may be held at the angles for the closing position and the opening position by a stopper. The lateral direction may be inclined with respect to the horizontal direction, and is not limited to the horizontal direction. The direction in which the coolant leakage prevention plate 52 and the rotary piece 53 hang down is not limited to the vertically downward direction. The angle formed by the coolant leakage prevention plate 52 and the rotary piece 53 is not limited to 90 degrees.

### EXPLANATION OF REFERENCE NUMERALS

1 MACHINE TOOL
2 BED
21 INSERTION PORT
22 ARRANGEMENT SPACE
3 SPLASH GUARD
4 COOLANT TANK (TANK)
41 TANK BODY
42 CHIP PAN
5 COOLANT LEAKAGE PREVENTION TOOL
51 HINGE
511 SHAFT
52 COOLANT LEAKAGE PREVENTION PLATE
53 ROTARY PIECE

What is claimed is:

1. A machine tool comprising:
a bed having an arrangement space on a side part;
a tank capable of being disposed in the arrangement space by insertion and capable of being pulled out from the arrangement space, the tank housing coolant generated during machining of a workpiece;
a coolant leakage prevention plate pivotable about a shaft extending in a horizontal direction, wherein the coolant leakage prevention plate is configured to be held at either a closing position or an open position, wherein at the closing position, the coolant leakage prevention plate hangs down from the shaft to cover at least a part of the tank which is inserted in the arrangement space, and wherein, when the tank is pulled out from the arrangement space, the coolant leakage prevention plate is pushed up by the tank being pulled out, whereby the coolant leakage prevention plate is caused to be at the open position to expose the arrangement space; and
a rotary piece pivotable about the shaft together with the coolant leakage prevention plate, wherein, when the coolant leakage prevention plate is positioned at the opening position, the rotary piece is configured to be held to hang down from the shaft, and wherein when the rotary piece is pushed by the tank which is inserted into the arrangement space, the rotary piece rotates together with the coolant leakage prevention plate, thereby positioning the coolant leakage prevention plate at the closing position.

2. The machine tool according to claim 1, wherein the coolant leakage prevention plate and the rotary piece are pivotably supported by the shaft capable of holding an angle.
